(19) United States
(12) Patent Application Publication
(10) Pub. No.: US 2002/0060880 A1
(43) Pub. Date: May 23, 2002

(54) Thin film magnetic heads and a method of producing the same

(75) Inventors: Takashi Kawabe, Hitachi-shi (JP); Shinji Narishige, Kanagawa-ken (JP); Tadayuki Iwakura, Odawara-shi (JP); Naoki Koyama, Tokyo (JP); Tetsuya Okai, Odawara-shi (JP)

Correspondence Address: MATTINGLY, STANGER & MALUR, P.C., 1800 DIAGONAL ROAD, SUITE 370, ALEXANDRIA, VA, 22314, US

(73) Assignee: Hitachi, Ltd.

(21) Appl. No.: 10/051,035

(22) Filed: Jan. 22, 2002

Related U.S. Application Data
(63) Continuation of application No. 09/161,394, filed on Sep. 28, 1998.

(30) Foreign Application Priority Data
Sep. 29, 1997 (JP) 09-263695

(51) Int. Cl. G11B 5/147

(52) U.S. Cl. 360/126

(57) ABSTRACT

A thin film magnetic head has a magnetic gap and two magnetic films that hold the magnetic gap therebetween to form a magnetic circuit. At least one of the two magnetic films has a first portion the surface of which is located remote from a throat height=0 point, and exposed to a recording medium and which determines a recording track width, and a second portion not exposed to the recording medium. The cross-sectional area of magnetic path in the second portion is larger than that in the first portion.

### BACKGROUND OF THE INVENTION

The present invention relates to thin film magnetic heads for use in a magnetic storage apparatus, and a method of producing the same.

In order to increase the recording density in a magnetic storage apparatus, it is absolutely necessary to raise not only the bit density but also the track density. In addition, to achieve the improvement in the track density, it is required to improve the head positioning precision and decrease the track widths of the magnetic heads.

So far, induction-type thin film magnetic heads have been employed as record/reproduce heads, but recently the improvement in the recording density has been rapidly advanced. At the present time, the integrated magnetic heads are generally used of which one part is a magnetoresistive effect (MR) head for reproduction or giant magnetoresistive effect (GMR) head for reproduction. However, even in these high-performance heads, the conventional induction type thin film magnetic head is still used as a record head. Therefore, in order to increase the recording density, it is essential to narrow the track width of the reproduce head, and to precisely decrease the width of the tip of the magnetic pole (magnetic film) that determines the record track width while the performance of the record head is kept high.

The important requirements for the performance of the record head are (1) large recording magnetic field, great field gradient and capability of reducing the magnetization transition length on the medium under an excellent O/W (overwrite) characteristic, (2) small recording field fringe, and capability of recording sharp magnetization transitions even at the track side ends, and (3) large recording efficiency, and capability of timely recording magnetization transitions even at the time of high frequency operation.

For the purpose of realizing these excellent recording performances, for example, increasing the recording field and field gradient, a thin film magnetic head is proposed of which a part of magnetic pole is made of a material Fe—Ta—N that has 1.5 to 1.8 T in saturated magnetic flux density, as disclosed in JPA 8-339508. In this document, the cross-sectional view of the thin film magnetic head is shown in which the usual upper magnetic core is divided into two parts and in which the tip end closer to the magnetic gap is made of Fe—Ta—N so that the recording characteristics are improved.

### SUMMARY OF THE INVENTION

It is an object of the invention to provide a thin film magnetic head that exhibits excellent recording performances even for a narrow track width of particularly 2 μm or below.

It is another object of the invention to provide a method of producing a thin film magnetic head capable of precisely forming narrow magnetic pole patterns corresponding to a track width of particularly 2 μm or below.

Since the prior art in JPA 8-339508 employs for part of magnetic pole a material of larger saturated magnetic flux density than the material of Parmalloy (1 T) used so far, the recording field and field gradient can be improved. In this prior art, only the head structure in the longitudinal cross-sectional direction is shown improved, but the effect of improvement cannot be seen on the head structure in the track width direction. In other words, there is no countermeasure against the situation that when the track width is narrow, the recording field is gradually reduced even if the saturated magnetic flux density is increased to about 1.8 T. For example, in the region where the surface recording density exceeds 2 Gb/in², the recording track width is often about 2 μm or below. Even if the magnetic pole is made of a material of about 1.8 T, simply narrowing the tip end width (track width) of the record head under the conventional structure will bring about gradual reduction of recording field so that the magnetization transitions cannot be recorded on the medium. Particularly when the coercive force of the medium must be increased as the recording density is improved, this reduction of recording field causes a large problem.

The subject in the present invention is to materialize a thin film magnetic head having an excellent recording performance for track widths of 2 μm or below and capable of forming narrow magnetic pole patterns with high precision, and a method of producing the thin film magnetic head.

In order to achieve the above subject, according to the present invention, there is provided a thin film magnetic head having a magnetic gap and two magnetic films holding the magnetic gap therebetween to form a magnetic circuit, wherein at least one of the magnetic films includes a first portion of which the surface away from a throat height=0 point is disposed near to a magnetic recording medium and exposed to the magnetic recording medium to determine a recording track width, and a second portion that is not exposed to the magnetic recording medium, and the cross-sectional area of the magnetic path in the second portion is made larger than that in the first portion.

The throat is those portions of magnetic films that are apart from the parallel condition in which the other portions of the magnetic films are substantially parallel with each other to hold a gap. The throat height is the distance between the upper magnetic core and lower magnetic core that hold only the recording gap film therebetween.

There is particularly no upper limit to the cross-sectional area of the magnetic path in the second portion from the functional point of view, but it is desired to have 30 times or below as large as the cross-sectional area of the magnetic path in the first portion from the standpoint of the size of the thin film magnetic head itself. Also, in this thin film magnetic head, it is desired that the second portion be at least partially thicker than the first portion.

Moreover, in order to achieve the above object, according to the invention, there is provided a thin film magnetic head having a magnetic gap and two magnetic films holding the magnetic gap therebetween to form a magnetic circuit, wherein at least one of the magnetic films includes a first portion of which the surface away from a throat height=0 point is disposed near to a magnetic recording medium and exposed to a magnetic recording medium to determine a recording track width, and a second portion that is not exposed to the magnetic recording medium, and the width of the second portion is made wider than that of the first portion and at least partially thicker than the first portion.

There is particularly no upper limit to the width and thickness of the second portion from the functional standpoint, but from the standpoint of the size of the thin film magnetic head itself they are desired to reduce to 20 times as wide as the width of the first portion, and 3 times as thick as the first portion.

Moreover, it is desired to provide a protective film over at least part of the surface of the first portion of either one of the above thin film magnetic heads.

In addition, in order to achieve the above object, according to the invention there is provided a thin film magnetic head having a magnetic gap and two magnetic films holding the magnetic gap therebetween to form a magnetic circuit, wherein at least one of the two magnetic films includes a second pattern with its one end placed between the surface to be faced to a magnetic recording medium and a throat height=0 point, and its other end placed inward (on the side opposite to the surface facing the magnetic recording medium) from the throat height=0 point, and a first pattern with its one end exposed to the magnetic recording medium to determine a recording track width, and its other end placed inside the one end of the second pattern, and at least parts of the first pattern and second pattern being piled.

In this thin film magnetic head, it is desired, that the other end of the first pattern (not determining the recording track width) be placed at the same point as the throat height=0 point or inside that point. Also, it is possible that the insulating film provided on the recording ga film is formed to have a two-layer structure, and that the other end of the first pattern is placed on the layer closer to the recording gap film, of this insulating film. It is also desired that the width of the one end (on the surface facing the magnetic recording medium) of the second pattern be made larger than that of the one end of the first pattern exposed to the magnetic recording medium. Furthermore, it is desired that the first pattern be formed to have a multilayer structure of two layers or above, with the first magnetic film or larger saturated magnetic flux density placed near to the recording gap film, and the second film of small saturated magnetic flux density placed distant from the recording gap film.

Even in either of the above thin film magnetic heads, the saturated magnetic flux density of the first portion or the first pattern should be the same as or larger than that of the second portion or the second pattern. Moreover, the specific resistance of the first portion or the first pattern should be the same as or larger than that of the second portion or the second pattern. The one end of the second portion or the second pattern that is closer to the surface facing the magnetic recording medium should be 0.2 μm or more distant from the surface facing the magnetic recording medium, more preferably 0.5 μm or above separated therefrom.

The above thin film magnetic heads are effective not only for the record/reproduce thin film magnetic heads but also for recording-only thin film magnetic heads that are used in combination with the reproduce heads such as MR heads or GMR heads as described in the prior art section.

In order to achieve the above object, according to the invention there is provided a method of producing the thin film magnetic heads including the steps of forming on a substrate a lower magnetic film, a magnetic gap film and a first insulating film to determine a throat height=0 point, depositing a first magnetic film pattern by use of a certain-thick photoresist in such a manner as to expose its one end to a magnetic recording medium to determine a recording track width and to place the other end at the throat height=0 point or inside this point (on the side opposite to the surface facing the magnetic recording medium), forming a conductive coil and a second insulating film, and depositing a second magnetic film pattern in such a way as to place its one end between the surface facing the magnetic recording medium and the throat height=0 point and to place the other end inside the throat height=0 point, thus an upper magnetic film being formed by the first and second magnetic film patterns, while the above desired thickness of the photoresist is made smaller than the sum of thickness values of the first and second insulating films.

The desired thickness of the photoresist should be 2 μm or above in order for process conditions to be easily selected.

Even when the track width is as narrow as 2 μm or below, excellent performance of recording can be realized by keeping the recording field large according to the invention. The reason for this will be described with reference to FIG. 2.

FIG. 2A is a perspective view of the shape of the upper magnetic core that determines the recording track width of the conventional thin film magnetic head. In FIG. 2A, only the head tip portion near to the surface facing the magnetic medium (hatched area) is shown, and the protective film formed on the upper magnetic core is omitted for the sake of better understanding. This thin film magnetic head has a lower magnetic core 207, a recording gap film 208, an upper magnetic core 200, and an insulating film 209. The tip of the insulating film 209 corresponds to the point of throat height=0. Although not shown, a coil is embedded in the insulating film 209 to excite the magnetic circuit (connected at the back of the magnetic head, though not shown) formed of the upper magnetic core 200 and lower magnetic core 207 so that a recording field is generated in the magnetic gap of the head tip.

FIG. 2B is a perspective view showing the shape of the tip portion of the thin film magnetic head according to the invention. The upper magnetic film tip that determines the recording track width includes a first portion 210 exposed to the magnetic medium, and a second portion 211 that is not exposed to the magnetic medium and that has a larger cross-sectional area of magnetic path than the first portion. The second portion 211 is wider (for example, 3 μm) than the first portion 210, and large in thickness. Although the invention has been mentioned with reference to FIG. 2B, an example of FIG. 2C can also be realized by the present invention. FIG. 2D is a graph showing the comparison between the invention and the conventional structure on the basis of the calculated values of the recording field (in the lengthwise recording direction) generated from the thin film magnetic heads of these types. Here, it is assumed that the track width, dimension d, saturated magnetic flux density and thickness of the upper magnetic core 200 and first portion 210, and spacing between the head and medium are 1.0 μm, 1.5 μm, 1.7 T and 3 μm, and 70 nm, respectively.

From FIGS. 2A to 2D, it will be seen that the conventional structure generates at most about 4800 Oe at a magnetomotive force of 0.7 AT when the track width is as narrow as 1 μm. Thus, it is difficult to make saturated recording enough to the recording medium of over 2000 Oe coercive force. On the other hand, the thin film magnetic head according to the invention can generate a magnetic field of 5000 Oe or above at a magnetomotive force of 0.4 AT. Thus, as compared with the conventional structure, the invention can produce a large recording field. Accordingly, magnetization transitions can be recorded properly on the medium. In addition, since it can be operated at a low magnetomotive force, the recording current can be reduced. Also, since the current switching time can be shorted with ease, high frequency recording and high speed transfer can be performed satisfactorily.

The reason for the large recording field and high recording efficiency according to the invention can be considered as below. In the conventional structure, as the track width narrows, the recording magnetic flux is easy to be saturated at the upper core (at 217 in FIG. 2A) corresponding to the slope of the insulating film, so that the amount of magnetic flux is reduced before arriving at the surface facing the magnetic medium. According to the invention, however, since the second portion 211 of a wide core width (see FIG. 2B) is close to the surface facing the magnetic medium, the amount of magnetic flux arriving at the head tip can be increased (the recording efficiency can be increased), so that a large recording field can be produced.

Although only the calculated results of the above dimensions (track width: 1 μm) are shown here as an example, it is actually necessary to increase the recording field and recording field gradient, make the track widthwise field and field gradient distribution uniform, and control the recording fringe on the track edges, thereby optimizing the head structure. The head of the above dimensions is not necessarily desired in all cases. In addition, although the upper magnetic core of the two upper and lower magnetic cores determines the trackwidth as described above, the same structure can be applied to the lower magnetic core. Moreover, it will be apparent that the recording field increasing effect according to the invention becomes more effective as the track width decreases. Particularly when a thin film magnetic head is made to have a recording track width of 2 μm or below, the effect is larger.

In addition, the recording field distribution and field gradient distribution can be improved by making the saturated magnetic flux density in the first portion that determines the actual recording track width, larger than that in the second portion. Since the second portion is larger in width or film thickness or both than the first portion, the recording magnetic flux is not easily saturated even if the saturated magnetic flux density is small. Moreover, if the specific resistance of the second portion is increased, the eddy current loss of the head decreases at the time of high frequency operation, and thus this thin film magnetic head becomes suited to high data transfer rate. Since it is important that the first portion have a large saturated flux density, the specific resistance may be smaller than that of the second portion, and thus materials can be freely selected with a small limitation. Furthermore, if the first portion is formed in such a lamination that two layers are laminated of which one layer near the recording gap has a large saturated flux density, and the other layer of which is formed on the one layer and has a small saturated flux density, the recording field distribution in the track width direction can be improved.

Thus, according to the invention, since a recording field large enough can be generated even if the recording rack width is as narrow as 2 μm or below, and since recording operation can be made at a low magnetomotive force, the magnetic disk apparatus with such heads is able to record at a high density and fast transfer data at a high frequency. In addition, according to the method of producing the head, the magnetic pole pattern of the thin film magnetic head that determines a recording track width of 2 μm or below can be formed with high precision, and therefore a high yield can be achieved.

### BRIEF DESCRIPTION OF THE DRAWINGS

FIG. 1 is a perspective view of a main part of the structure of a thin film magnetic head according to one embodiment of the invention.

FIG. 2A is a perspective view of a main part of the structure of a conventional thin film magnetic head.

FIGS. 2B and 2C are perspective views of main parts of different structures according to the embodiment of the invention.

FIG. 2D is a graph showing the comparison between the conventional thin film head of FIG. 2a and the thin film head of FIG. 2B according to the invention on the basis of magnetomotive force and lengthwise maximum recording field.

FIGS. 3A and 3B are a perspective view and side cross-sectional view showing a main part of the structure of a thin film magnetic head according to another embodiment of the invention.

FIGS. 4A and 4B are a perspective view and side cross-sectional view showing a main part of the structure of a thin film magnetic head according to still another embodiment of the invention.

FIGS. 5A to 5D are diagrams for manufacturing processes showing a method of producing a thin film magnetic head according to one embodiment of the invention.

FIG. 6 is a perspective view of one example of a magnetic storage apparatus using thin film magnetic heads according to the invention.

### DESCRIPTION OF THE PREFERRED EMBODIMENTS

Some embodiments of the invention will be described with reference to the accompanying drawings.

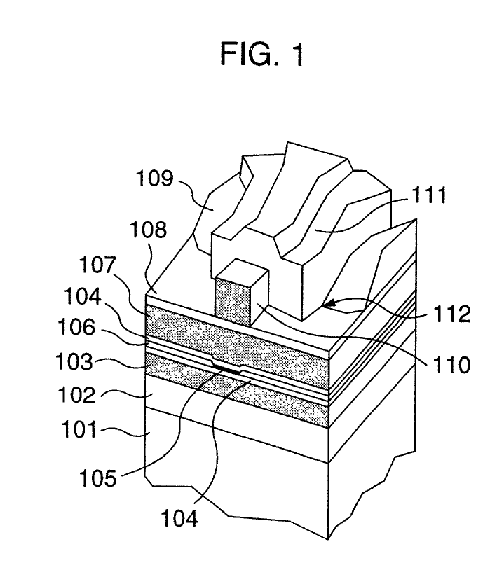

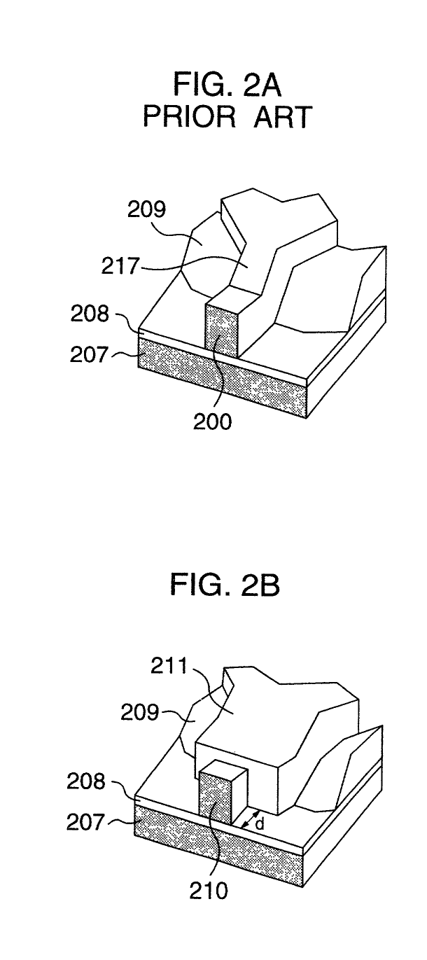

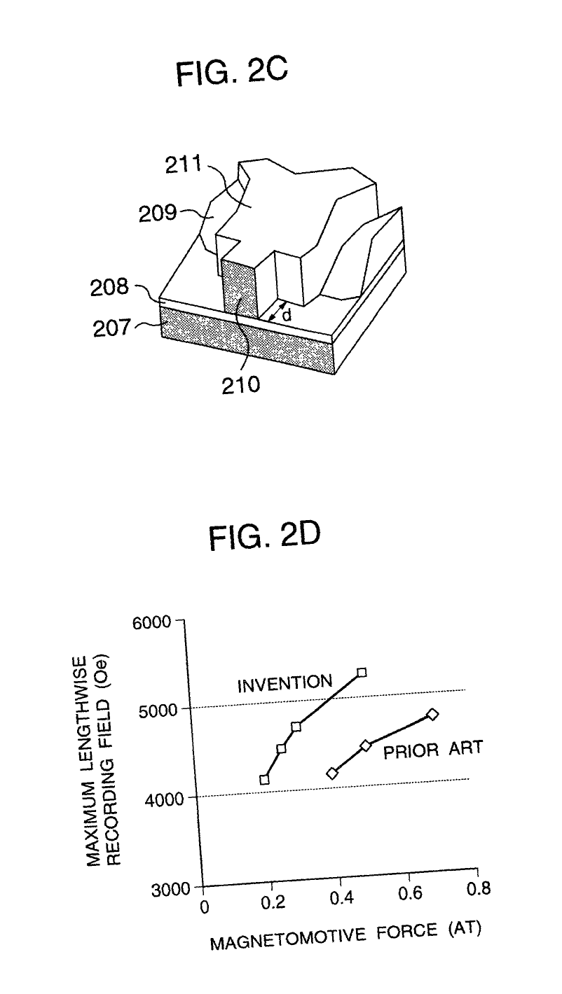

FIG. 1 is a perspective view showing the shape of the upper magnetic core that determines the recording tack width of a thin film magnetic head as one embodiment of the invention. Only the structure of the head tip portion near the surfaces (hatched areas) facing a magnetic medium is illustrated, and a protective film formed on the upper magnetic core is omitted for the sake of better understanding. The materials, dimensions and films shown here are only one example, and may be changed without departing from the scope of the invention.

This thin film magnetic head has a substrate 101 made of, for example, Al₂O₃—TiC-based ceramic, an underlayer film 102 of Al₂O₃, a lower shield film 103 of FeAlSi that constitutes an MR head portion as a reproduce head, a reproducing gap film 104 of Al₂O₃, an MR sensor film 105 of NiFe laminated film, an electrode film 106 of Ta laminated film, an upper shield film of NiFe (also acting as a lower magnetic core of the magnetic head) 107, and a recording gap film (0.3 μm in thickness) 108 of Al₂O₃. In addition, an organic insulating film 109 (within which a coil is embedded, though not shown) of heat-cured photoresist, and an upper magnetic core are provided on the recording gap film. The upper magnetic core is composed of two different shape portions: a first portion (2.0 μm in thickness) 110 of which the end surface is exposed to, for example, a magnetic medium (not shown) and that determines the track width (1.0 μm), and a second portion 111 not exposed to the magnetic medium, and that is larger in width (3.0 μm) and thickness (3.0 μm) than the first portion.

Here, the first portion 110 is made of CoNiFe that provides a saturated magnetic flux density of 1.6 T, and the second portion 111 is made of NiFe that exhibits a saturated magnetic flux density of 1.0 T. The tip of the second portion 111 is placed, for example, 2.0 μm forward (close to the surface facing the magnetic medium) from a throat height=0 point 112, and the distance from that position to the tip (the position of the surface facing the medium) of the first portion 110 is selected to be, for example, 1.5 μm.

The thin film magnetic head thus produced was compared with the conventional structure of thin film magnetic head as to the overwrite characteristic when the track width is 1.0 μm. From the comparison, it was confirmed that under conditions of, for example, magnetomotive force 0.4 AT, medium's coercive force 2500 Oe, and head-medium spacing 70 nm, the conventional head exhibited −22 dB, while this embodiment showed −36 dB, that is, the recording characteristic was improved by the increase of recording field.

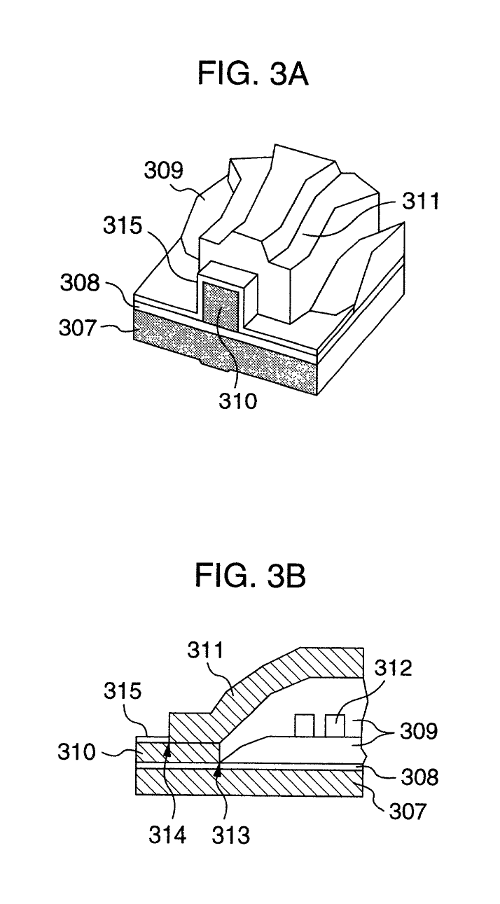

FIG. 3A is a perspective view showing the structure of the upper magnetic core of a thin film magnetic head as another embodiment of the invention. FIG. 3B is a side cross-sectional view of the structure of FIG. 3A. Since the structure of MR sensor film, electrode film and reproducing gap film from the substrate is the same as in FIG. 1, it was omitted. In this thin film magnetic head, an organic insulating film 309 of heat-cured photoresist, a coil 312 of Cu and the upper magnetic core are formed over an upper shield film (also serving as the lower magnetic core of the record head) 307 of, for example, NiFe and a recording gap film (0.3 μm thick) 308 of Al₂O₃.

The upper magnetic core is composed of two different shape portions as illustrated in FIG. 3B: a first pattern (2.5 μm thick) 310 that has a surface facing a magnetic medium (not shown) and that determines the track width (1.2 μm), and a second pattern (4.0 μm) 311 that is not exposed to the magnetic medium and that forms the back of the magnetic core. The other end 313 of the first pattern 310, not exposed to the magnetic medium surface, is placed inward from the tip 314 of the second pattern is order to assure a magnetically coupling area between the first and second patterns. In addition, as is the same as in FIG. 1, the first pattern 310 is made of, for example, CoNiFe or NiFe that exhibits a saturated flux density of 1.6 T, and the second pattern 311 is made of, for example, NiFe that shows a saturated flux density of 1.0 T. Moreover, a protective film (0.5 μm thick) 315 of, for example, Al₂O₃ is provided on the surface of the first pattern, thereby protecting the first pattern surface from being damaged during the deposition of the second pattern. However, as illustrated in FIG. 3B, this protective film is removed at the junction between the first and second patterns, so that the magnetic coupling can be assured.

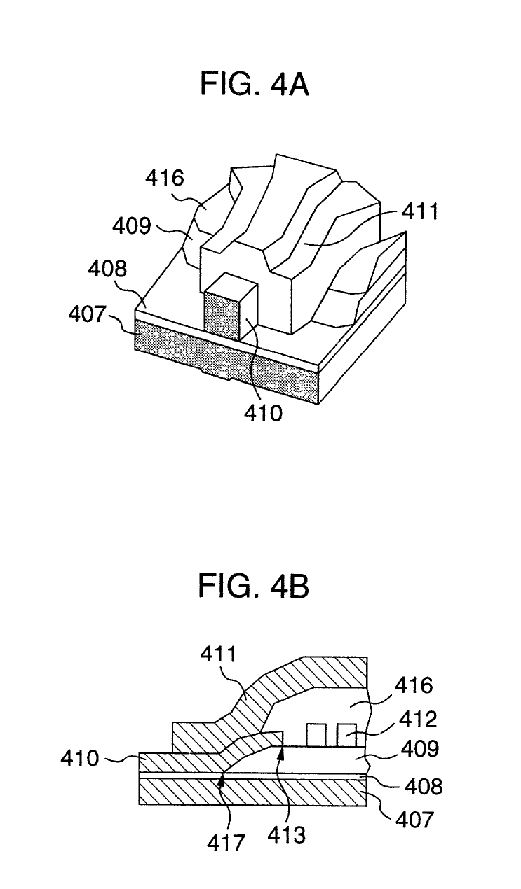

FIG. 4A is a perspective view showing the structure of the upper magnetic core of a thin film magnetic head as still another embodiment of the invention. FIG. 4B is a side cross-sectional view of the structure of FIG. 4A. Since the structure of MR sensor film, electrode film and reproducing gap film from the substrate is the same as in FIG. 1, it is omitted here. In this thin film magnetic head, a first organic insulating film 409 made of heat-cured photoresist, a coil 412 of Cu, a second organic insulating film 416 made of heat-cured photoresist, and the upper magnetic core are formed over an upper shield film (also serving as the lower magnetic core of the record head) 407 of, for example, NiFe and a recording gap film (0.3 μm thick) 408 of, for example, Al₂O₃.

The upper magnetic core is formed of two different shape portions as shown in FIG. 4B: a first pattern (3.1 μm thick) 410 that is exposed to a magnetic recording medium surface (not shown) and that determines the track width (1.2 μm), and a second pattern (4.0 μm thick) 411 that is not exposed to the magnetic medium surface and that constitutes the back of the magnetic core. Here, the other end 413 of the first pattern 410 that is not exposed to the magnetic medium surface is placed on the first organic insulating film 409 beyond a throat height=0 point 417.

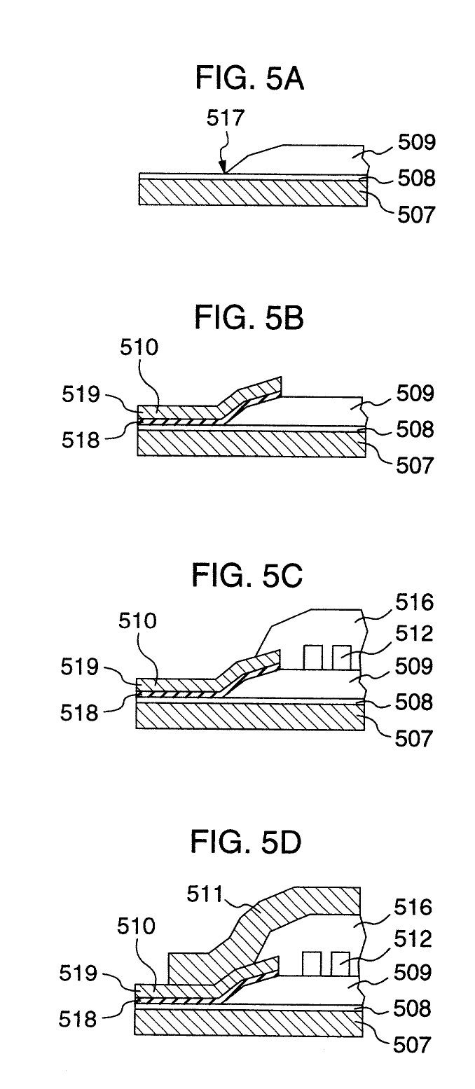

FIGS. 5A-5D are a cross-sectional flow diagram for manufacturing processes showing a method of producing the thin film magnetic head as one embodiment of the invention. Here, the thin film magnetic head shown in FIGS. 4A and 4B is produced according to this flow diagram. In addition, as is the same as mentioned so far, the structure of MR sensor film, electrode film and reproducing gap film from the substrate is omitted. First, after an upper shield film (also serving as the lower magnetic core of the record head, 3.0 μm thick) 507 of NiFe and a recording gap film (0.3 μm thick) 508 of Al₂O₃ are formed, a first organic insulating film (heat-cured photoresist, 3.0 μm thick) 509 that determines a throat height=0 point 517 is deposited over those films, as shown in FIG. 5A. Then, an upper magnetic film, first pattern (3.5 μm thick) 510 that determines the recording track width is formed by plating that uses a photoresist 4.0 μm thick (not shown), as shown in FIG. 5B. The plated film is a double layer film that is composed of an FeNi film (1.0 μm thick) 518 that exhibits a saturated flux density of 1.7 T, and an NiFe film (2.5 μm thick) 519 which shows a saturated flux density of 1.0 T. Thereafter, as shown in FIG. 5C, a coil (2.5 μm thick) 512 and a second organic insulating film (6.0 μm) 516 are formed over the first organic insulating film. Over the first pattern and second organic insulating film, there is formed an upper magnetic film second pattern (NiFe, 4.0 μm thick) 511 as illustrated in FIG. 5D. In this case, the upper magnetic second pattern was deposited by plating that uses a photoresist 12 μm thick (not shown). The values of film thickness given above are an example of the invention.

According to the conventional structure of thin film magnetic head, in order to determine the recording track width, it was necessary that a photoresist pattern be formed on a step having the height corresponding to the sum of the thickness values of the first and second insulating films, thus making the upper magnetic core pattern. As a result, a pattern for determining a track width of 2 μm or below was required to be produced by use of a photoresist 10 μm or above, and thus it was difficult to produce a precise pattern. On the other hand, according to the present invention, since the thickness of the photoresist can be reduced to about half as much, or for example, 4 μm, it is possible to make a high precision pattern of 1 μm or below. Accordingly, the invention is advantageous in that a thin film magnetic head of narrow track structure can be produced with ease. More specifically, magnetic heads for a track width of 2 μm or below was difficult to be produced by the conventional method, while thin film magnetic heads for a track width of 0.6 μm minimum can be produced by the method of the invention utilizing the above effect of photoresist thickness reduction.

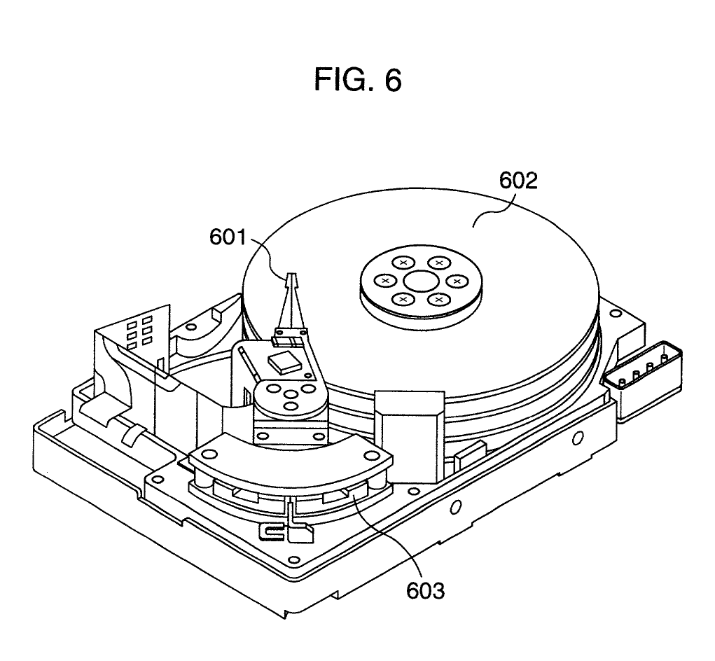

FIG. 6 is a perspective view of one example of a magnetic storage apparatus. For better understanding, it is uncovered. A thin film magnetic head 601 of the above heads according the invention is mounted on an arm that is secured to the tip of a positioning mechanism 603. This head is thus placed on a rotatable magnetic recording medium 602 to write and read information on and from the magnetic recording medium 603. This magnetic storage apparatus further has a drive motor for driving the medium 602 to rotate, control means for controlling this drive motor, an electromagnetic transducer to write and read information, a control circuit for the transducer, and another control circuit to control the positioning mechanism 603.

The present invention is able to produce thin film magnetic heads capable of satisfactorily recording information even on tracks 1.4 μm wide. As one example of the effect, we have produced a magnetic disk recording apparatus capable of recording at a track density of 15 kTPI (15,000 tracks per inch), surface recording density of 3.6 Gb/in², and a 6-Gb magnetic recorder using three disks of 2.5 in. in diameter.

What is claimed is:

1. A thin film magnetic head having a function to record information on a magnetic recording medium comprising:
a magnetic gap; and
two magnetic films holding said magnetic gap therebetween to form a magnetic circuit, wherein at least one of said two magnetic films has a first portion of which the surface remote from a throat height=0 point is disposed near to said recording medium and exposed to said recording medium and which determines a recording track width, and a second portion that has no surface exposed to said magnetic recording medium, and the cross-sectional area of the magnetic path in said second portion is larger than that in said first portion.

2. A thin film magnetic head having a function to record information on a magnetic recording medium comprising:
a magnetic gap; and
two magnetic films holding said magnetic gap therebetween to form a magnetic circuit, wherein at least one of said two magnetic films has a first portion of which the surface remote from a throat height=0 point is disposed near to said recording medium and exposed to said recording medium and which determines a recording track width, and a second portion that has no surface exposed to said surface of said magnetic recording medium, and said second portion is wider than said first portion, and at least partially thicker than said first portion.

3. A thin film magnetic head having a function to record information on a magnetic recording medium comprising:
a magnetic gap; and
two magnetic films holding said magnetic gap therebetween to form a magnetic circuit, wherein at least one of said two magnetic films comprises a second pattern that has its one end placed between the surface to be opposed to said magnetic recording medium and a throat height=0 point, and its other end placed on the side opposite to said surface facing said magnetic recording medium beyond said throat height=0 point, and a first pattern having its one end exposed to said magnetic recording medium to determine a recording track width, and its other end placed on the side opposite to the side facing said magnetic recording medium away from said one end of said second pattern, and said first and second patterns are at least partially piled.

4. A method of producing a thin film magnetic head comprising the steps of:
forming on a substrate a lower magnetic film, a magnetic gap film, and a first insulating film for determining a throat height=0 point;
forming a first magnetic film pattern by use of a photoresist film of a desired thickness, said first magnetic film pattern having its one end exposed to a magnetic recording medium to determine a recording track width, and its other end placed at said throat height=0 point or on the side opposite to the surface facing to said magnetic recording medium away from said point;
forming a conductive coil and a second insulating film; and
forming a second magnetic film pattern having its one end placed between the surface facing said magnetic recording medium and said throat height=0 point, and its other end placed on the side opposite to the surface facing said magnetic recording medium beyond said throat height=0 point, said first and second magnetic film patterns being combined to form an upper magnetic film.

5. A method according to claim 4, wherein the desired thickness of said photoresist film is smaller than the sum of the thickness values of said first and second insulating films.
